(19) United States
(12) Patent Application Publication
(10) Pub. No.: US 2023/0122031 A1
(43) Pub. Date: Apr. 20, 2023

(54) SYSTEMS AND METHODS FOR PROVIDING CONTENT CANDIDATES

(71) Applicant: GOOGLE LLC, Mountain View, CA (US)

(72) Inventor: Jonathan Conley, Mountain View, CA (US)

(73) Assignee: GOOGLE LLC, Mountain View, CA (US)

(21) Appl. No.: 17/048,785

(22) PCT Filed: Jun. 26, 2019
(86) PCT No.: PCT/US2019/039273

§ 371 Date: Oct. 19, 2020

(51) Int. Cl. G06F 16/9535; G06F 16/951

(52) U.S. Cl. CPC G06F 16/9535; G06F 16/951

(57) ABSTRACT

The present disclosure is directed to a method for providing content candidates. The method includes maintaining, in a first data structure, a first set of data including a domain of a web page. The method includes maintaining, in a second data structure, a second set of data including a subset of content candidates. The method includes generating a first vector based on a semantic content of the domain of the web page. The method includes generating a second vector based on a semantic content of a content candidate selected from the subset of content candidates. The method includes determining a distance on a learned space between the first vector and the second vector. The method includes associating, responsive to the distance satisfying a distance threshold, the content candidate with the domain of the web page.

### BACKGROUND

In a computer networked environment such as the internet, third-party content providers provide content items for display on end-user computing devices. These third-party content items, for example, advertisements (ads), can be linked to web pages associated with the third-party content providers. These third-party content items can include content identifying the third-party content provider that provided the content item.

### BRIEF SUMMARY

In one aspect, the present disclosure is directed to a method for providing content candidates. The method can include maintaining, in a first data structure of a system, a first set of data including a domain of a web page. The method can include maintaining, in a second data structure of the system, a second set of data including a subset of content candidates. The method can include generating, by the system, a first vector based on a semantic content of the domain of the web page. The method can include generating, by the system, a second vector based on a semantic content of a first content candidate selected from the subset of content candidates. The method can include generating, by the system, a third vector based on a semantic content of a second content candidate selected from the subset of content candidates. The method can include determining, by the system, a first distance on a learned space between the first vector and the second vector. The method can include associating, by the system responsive to the first distance satisfying a distance threshold, the first content candidate with the domain of the web page. The method can include determining, by the system, a second distance on the learned space between the first vector and the third vector. The method can include disassociating, by the system responsive to the second distance not satisfying the distance threshold, the second content candidate with the domain of the web page.

In some implementations, maintaining a second set of data including a plurality of content candidates can further include receiving, by the system, a plurality of content candidates including the subset of content candidates. Such an operation can further include monitoring, by the system for each of the plurality of content candidates, a respective click-through-rate associated with the web page. Such an operation can further include selecting, by the system, the subset of content candidates based on determining that the respective click-through-rate of each of the subset of content candidates satisfies a rate threshold. Such an operation can further include storing, in the second data structure, the subset of content candidates.

In some implementations, generating a first vector based on a semantic content of the domain of the web page can further include identifying, by the system via a natural language processing technique, a reference to web resources corresponding to the web page. Such an operation can further include segmenting, by the system, the web address to one or more semantic content candidates. Such an operation can further include selecting, by the system, one of the one or more semantic content candidates as the domain.

In some implementations, generating a second vector based on a semantic content of a first content candidate selected from the subset of content candidates can further include identifying, by the system via a natural language processing technique, the semantic content of a link of the first content candidate. Such an operation can further include generating, by the system, the second vector based on the semantic content of the link of the first content candidate. Generating a third vector based on a semantic content of a second content candidate selected from the subset of content candidates can further include identifying, by the system via the natural language processing technique, the semantic content of a link of the second content candidate. Such an operation can further include generating, by the system, the third vector based on the semantic content of the link of the second content candidate.

In some implementations, determining a first distance on a learned space between the first vector and the second vector can further include identifying, by the system, a click-through-rate of the first content candidate with respect to the web page. Such an operation can further include calculating, by the system, a dot product of the first and second vectors as the first distance based on the click-through-rate of the first content candidate. Determining a second distance on a learned space between the first vector and the third vector further can further include identifying, by the system, a click-through-rate of the second content candidate with respect to the web page. Such an operation can further include calculating, by the system, a dot product of the first and third vectors as the second distance based on the click-through-rate of the second content candidate.

In some implementations, the method can further include iteratively determining, by the system, that the first distance is less than the distance threshold. The method can further include iteratively assigning, by the system, the first content candidate with a first relevance score to prioritize selecting the first content candidate. The method can further include maintaining, in the second data structure, the first relevance score.

In some implementations, the method can further include iteratively determining, by the system, that the second distance is equal to or greater than the distance threshold. The method can further include iteratively assigning, by the system, the second content candidate with a second relevance score to deprioritize selecting the second content candidate. The method can further include maintaining, in the second data structure, the second relevance score.

In another aspect, the present disclosure is directed to a system to provide content candidates. The system can include one or more hardware processors configured by machine-readable instructions. The one or more processors, configured by the machine-readable instructions, can maintain, in a first data structure, a first set of data including a domain of a web page. The one or more processors, configured by the machine-readable instructions, can maintain, in a second data structure, a second set of data including a subset of content candidates. The one or more processors, configured by the machine-readable instructions, can generate a first vector based on a semantic content of the domain of the web page. The one or more processors, configured by the machine-readable instructions, can generate a second vector based on a semantic content of a first content candidate selected from the subset of content candidates. The one or more processors, configured by the machine-readable instructions, can generate a third vector based on a semantic content of a second content candidate selected from the subset of content candidates. The one or more processors, configured by the machine-readable instructions, can determine a first distance on a learned space between the first vector and the second vector. The one or more processors, configured by the machine-readable instructions, can associate, responsive to the first distance satisfying a distance threshold, the first content candidate with the domain of the web page. The one or more processors, configured by the machine-readable instructions, can determine a second distance on a learned space between the first vector and the third vector. The one or more processors, configured by the machine-readable instructions, can disassociate, responsive to the second distance not satisfying a distance threshold, the second content candidate with the domain of the web page.

In some implementations, the one or more processors, configured by the machine-readable instructions, can further receive a plurality of content candidates including the subset of content candidates. The one or more processors, configured by the machine-readable instructions, can further monitor, for each of the plurality of content candidates, a respective click-through-rate associated with the web page. The one or more processors, configured by the machine-readable instructions, can further select the subset of content candidates based on determining that the respective click-through-rate of each of the subset of content candidates satisfies a rate threshold. The one or more processors, configured by the machine-readable instructions, can further store, in the second data structure, the subset of content candidates.

In some implementations, the one or more processors, configured by the machine-readable instructions, can further identify, via a natural language processing technique, a reference to web resources corresponding to the web page. The one or more processors, configured by the machine-readable instructions, can further segment the web address to one or more semantic content candidates. The one or more processors, configured by the machine-readable instructions, can further select one of the one or more semantic content candidates as the domain.

In some implementations, the one or more processors, configured by the machine-readable instructions, can further identify, via a natural language processing technique, the semantic content of a link of the first content candidate. The one or more processors, configured by the machine-readable instructions, can further generate the second vector based on the semantic content of the link of the first content candidate. The one or more processors, configured by the machine-readable instructions, can further identify, via the natural language processing technique, the semantic content of a link of the second content candidate. The one or more processors, configured by the machine-readable instructions, can further generate the third vector based on the semantic content of the link of the second content candidate.

In some implementations, the one or more processors, configured by the machine-readable instructions, can further identify a click-through-rate of the first content candidate with respect to the web page. The one or more processors, configured by the machine-readable instructions, can further calculate a dot product of the first and second vectors as the first distance based on the click-through-rate of the first content candidate. The one or more processors, configured by the machine-readable instructions, can further identify a click-through-rate of the second content candidate with respect to the web page. The one or more processors, configured by the machine-readable instructions, can further calculate a dot product of the first and third vectors as the second distance based on the click-through-rate of the second content candidate.

In some implementations, the one or more processors, configured by the machine-readable instructions, can further iteratively determine that the first distance is less than the distance threshold. The one or more processors, configured by the machine-readable instructions, can further iteratively assign the first content candidate with a first relevance score to prioritize selecting the first content candidate. The one or more processors, configured by the machine-readable instructions, can further maintain, in the second data structure, the first relevance score.

In some implementations, the one or more processors, configured by the machine-readable instructions, can further iteratively determine that the second distance is equal to or greater than the distance threshold. The one or more processors, configured by the machine-readable instructions, can further iteratively assign the second content candidate with a second relevance score to deprioritize selecting the second content candidate. The one or more processors, configured by the machine-readable instructions, can further maintain, in the second data structure, the second relevance score.

In yet another aspect, the present disclosure is directed to a non-transient computer readable storing program instructions. The program instructions can cause one or more processors to maintain, in a first data structure, a first set of data including a domain of a web page. The program instructions can cause the one or more processors to maintain, in a second data structure, a second set of data including a subset of content candidates. The program instructions can cause the one or more processors to generate a first vector based on a semantic content of the domain of the web page. The program instructions can cause the one or more processors to generate a second vector based on a semantic content of a first content candidate selected from the subset of content candidates. The program instructions can cause the one or more processors to generate a third vector based on a semantic content of a second content candidate selected from the subset of content candidates. The program instructions can cause the one or more processors to determine a first distance on a learned space between the first vector and the second vector. The program instructions can cause the one or more processors to associate, responsive to the first distance satisfying a distance threshold, the first content candidate with the domain of the web page. The program instructions can cause the one or more processors to determine a second distance on the learned space between the first vector and the third vector. The program instructions can cause the one or more processors to disassociate, responsive to the second distance not satisfying the distance threshold, the second content candidate with the domain of the web page

In some implementations, the program instructions can cause the one or more processors further to identify, via a natural language processing technique, a reference to web resources corresponding to the web page. The program instructions can cause the one or more processors further to segment the web address to one or more semantic content candidates. The program instructions can cause the one or more processors further to select one of the one or more semantic content candidates as the domain.

In some implementations, the program instructions can cause the one or more processors further to identify, via a natural language processing technique, the semantic content of a link of the first content candidate. The program instructions can cause the one or more processors further to generate the second vector based on the semantic content of the link of the first content candidate. The program instructions can cause the one or more processors further to identify, via the natural language processing technique, the semantic content of a link of the second content candidate. The program instructions can cause the one or more processors further to generate the third vector based on the semantic content of the link of the second content candidate

In some implementations, the program instructions can cause the one or more processors further to identify a click-through-rate of the first content candidate with respect to the web page. The program instructions can cause the one or more processors further to calculate a dot product of the first and second vectors as the first distance based on the click-through-rate of the first content candidate. The program instructions can cause the one or more processors further to identify a click-through-rate of the second content candidate with respect to the web page. The program instructions can cause the one or more processors further to calculate a dot product of the first and third vectors as the second distance based on the click-through-rate of the second content candidate

In some implementations, the program instructions can cause the one or more processors further to iteratively determine that the first distance is less than the distance threshold. The program instructions can cause the one or more processors further to iteratively assign the first content candidate with a first relevance score to prioritize selecting the first content candidate. The program instructions can cause the one or more processors further to maintain, in the second data structure, the first relevance score.

In some implementations, the program instructions can cause the one or more processors further to iteratively determine that the second distance is greater than the distance threshold. The program instructions can cause the one or more processors further to iteratively assign the second content candidate with a second relevance score to deprioritize selecting the second content candidate. The program instructions can cause the one or more processors further to maintain, in the second data structure, the second relevance score.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a block diagram depicting one implementation of an environment for assessing one or more advertisements in real-time in a computer network environment, according to an illustrative implementation;

FIG. 2 is an example web page including one or more content candidates that are selected to be displayed, according to an illustrative implementation;

FIG. 3 is a flow diagram depicting a method of associating content candidates with a web page based on semantic contents of the content candidates, according to an illustrative implementation; and

FIG. 4 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of providing content candidates. The various concepts introduced above and discussed in greater detail below may be implemented in any of numerous ways, as the described concepts are not limited to any particular manner of implementation.

Advertisers may serve advertisements to increase brand awareness as well as provide more relevant content to users. The advertisements may be implemented as a variety of forms to interact with the users. For example, the advertisements may be served as one or more content links over one or more information resources (e.g., a web page, a video feed, or the like). When the users access the information resources, the users may interact with such content links. In the implementations that do not utilize systems and methods of the present disclosure, the advertisers generally use a system to select the content links from a pool of content candidates, which may sometimes be referred to as “radlink candidates.” For example, in response to identifying the domain name (or domain) of a web page where the advertisers intended to present the content links, the system may assign the domain name into a respective category. Based on the category to which the domain name is assigned, a number of radlink candidates are identified or categorized. Relying on such a coarse filtering method to select radlink candidates may cause various issues such as, for example, missing to assign radlink candidate(s) that are actually relevant to a particular category. Accordingly, the performance of such radlink candidates (e.g., click-through-rates (CTRs)) may be disadvantageously affected, which in turn can cause additional resource costs to the respective advertisers.

The present disclosure provides systems and methods for a technical solution to the above-identified problem by associating one or more content candidates with a web page based on respective semantic contents of the one or more content candidates. In some embodiments, the disclosed system can include, manage, or otherwise interact with two data structures. One data structure can provide the domain of a web page to generate a first vector. The other data structure can provide a selected one of a number of content candidates to generate a second vector. The system can compare how semantically relevant the domain and each of the content candidates are based on a distance between the two vectors. The system can identify that the content candidate is semantically relevant to the domain upon determining the distance satisfying a distance threshold. Accordingly, the system can determine not only a semantic relationship between the domain and each of the content candidates, but also a measure of how semantically relevant each of the content candidates is with respect to the domain.

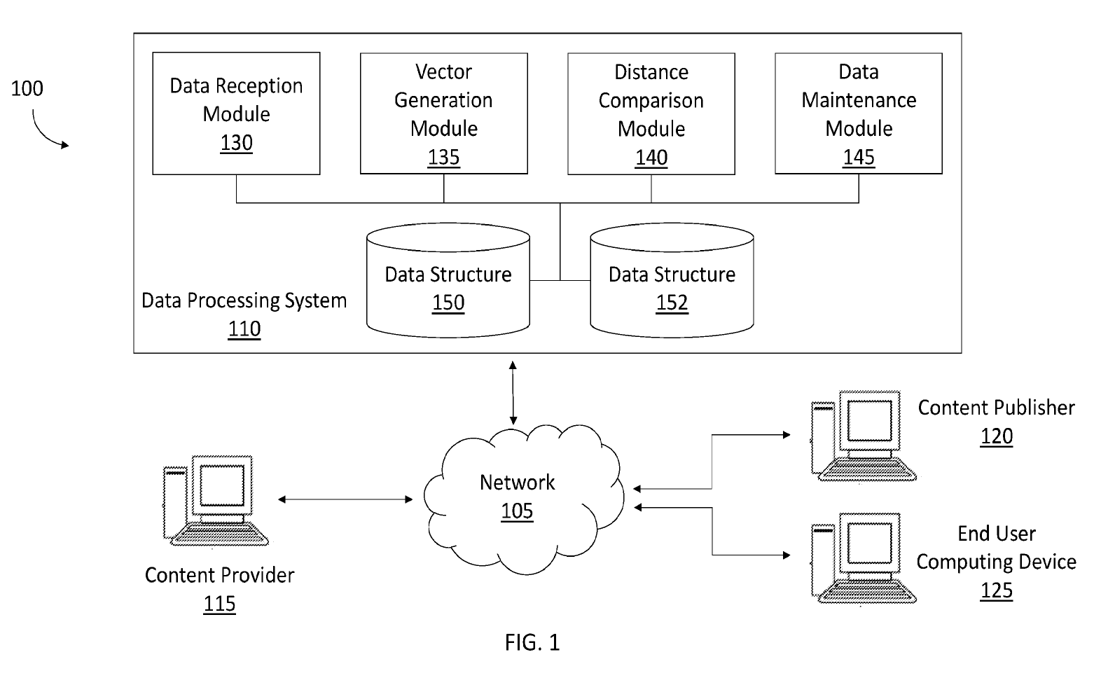

FIG. 1 is a block diagram depicting one implementation of an environment for associating content candidates with a web page based on semantic contents of the content candidates. The environment 100 includes at least one data processing system 110. The data processing system 110 can include at least one processor and a memory, i.e., a processing circuit. The memory stores processor-executable instructions that, when executed by processor, cause the processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language. The data processing system can include one or more computing devices or servers that can perform various functions. In some implementations, the data processing system can include an advertising auction system configured to host auctions. In some implementations, the data processing system does not include the advertising auction system but is configured to communicate with the advertising auction system via the network 105.

The network 105 can include computer networks such as the internet, local, wide, metro or other area networks, intranets, satellite networks, other computer networks such as voice or data mobile phone communication networks, and combinations thereof. The data processing system 110 of the system 100 can communicate via the network 105, for instance with at least one content provider computing device 115, at least one content publisher computing device 120, or at least one end user computing device 125. The network 105 may be any form of computer network that relays information between the user computing device 115, data processing system 110, and one or more content sources, for example, web servers, advertising servers, amongst others. For example, the network 105 may include the Internet and/or other types of data networks, such as a local area network (LAN), a wide area network (WAN), a cellular network, satellite network, or other types of data networks. The network 105 may also include any number of computing devices (e.g., computer, servers, routers, network switches, etc.) that are configured to receive and/or transmit data within network 105. The network 105 may further include any number of hardwired and/or wireless connections. For example, the user computing device 115 may communicate wirelessly (e.g., via WiFi, cellular, radio, etc.) with a transceiver that is hardwired (e.g., via a fiber optic cable, a CAT5 cable, etc.) to other computing devices in network 105.

The content provider computing devices 115 can include servers or other computing devices operated by a content provider entity to provide content items such as content candidates, upon being selected, for display on information resources at the end user computing device 125. The content candidates can be provided by one or more respective advertisers. In some implementations, a content candidate can sometimes be referred to as an advertising candidate. Each of the content candidates can include a link to a number of advertising links. Each of the advertising links, upon being activated (e.g., clicked), can lead to a result of a landing web page. The selected content candidates can be provided through the content provider computing device 115. The link of the selected content candidate can be displayed on information resources provided by the content publisher computing device 120.

The above-mentioned information resources can include a website or web page that includes primary content, e.g. content provided by the content publisher computing device 120. The content items can also be displayed on a search results web page. For instance, the content provider computing device 115 can provide or be the source of advertisements or other content items for display in content slots of content web pages, such as a web page of a company where the primary content of the web page is provided by the company, or for display on a search results landing page provided by a search engine. The content items associated with the content provider computing device 115 can be displayed on information resources other than web pages, such as content displayed as part of the execution of an application on a smartphone or other end user computing device 125.

The content publisher computing devices 120 can include servers or other computing devices operated by a content publishing entity to provide primary content for display via the network 105. For instance, the content publisher computing device 120 can include a web page operator who provides primary content for display on the web page. The primary content can include content other than that provided by the content publisher computing device 120, and the web page can include content slots configured for the display of third party content items (e.g., ads) from the content provider computing devices 115. For instance, the content publisher computing device 120 can operate the website of a company and can provide content about that company for display on web pages of the website. The web pages can include content slots configured for the display of third party content items such as ads of the content provider computing device 115. In some implementations, the content publisher computing device 120 includes a search engine computing device (e.g. server) of a search engine operator that operates a search engine website. The primary content of search engine web pages (e.g., a results or landing web page) can include results of a search as well as third party content items displayed in content slots such as content items from the content provider computing device 115. In some implementations, the content publisher computing device 120 can include a server for serving video content.

The end user computing devices 125 can include computing devices configured to communicate via the network 105 to display data such as the content provided by the content publisher computing device 120 (e.g., primary web page content or other information resources) and the content provided by the content provider computing device 115 (e.g., third party content items such as ads configured for display in a content slot of a web page). The end user computing device 125, the content provider computing device 115, and the content publisher computing device 120 can include desktop computers, laptop computers, tablet computers, smartphones, personal digital assistants, mobile devices, consumer computing devices, servers, clients, digital video recorders, a set-top box for a television, a video game console, or any other computing device configured to communicate via the network 105. The end user computing devices 125 can be communication devices through which an end user can submit requests to receive content. The requests can be requests to a search engine and the requests can include search queries. In some implementations, the requests can include a request to access a web page.

The content provider computing devices 115, the content publisher computing device 120 and the end user computing devices 125 can include a processor and a memory, i.e., a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language.

The content provider computing devices 115, the content publisher computing devices 120, and the end user computing devices 125 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the content provider computing devices 115, the content publisher computing device 120 and the end user computing devices 125 (e.g., a built-in display, microphone, etc.) or external to the housing of content provider computing devices 115, the content publisher computing device 120 and the end user computing devices 125 (e.g., a monitor connected to the user computing device 115, a speaker connected to the user computing device 115, etc.), according to various implementations. For example, the content provider computing devices 115, the content publisher computing device 120 and the end user computing devices 125 may include an electronic display, which visually displays web pages using webpage data received from one or more content sources and/or from the data processing system 110 via the network 105. In some implementations, a content placement campaign manager or third-party content provider, such as an advertiser, can communicate with the data processing system 110 via the content provider computing device 115. In some implementations, the advertiser can communicate with the data processing system 110 via a user interface displayed on the user interface devices of the content provider computing device 115.

The data processing system 110 can include at least one server. For instance, the data processing system 110 can include a plurality of servers located in at least one data center or server farm. In some implementations, the data processing system 110 includes a content placement system, e.g., an ad server or ad placement system. The data processing system 110 can include at least one data reception module 130, at least one vector generation module 135, at least one distance comparison module 140, a data maintenance module 145, a first data structure 150, and a second data structure 152. The data reception module 130, vector generation module 135, distance comparison module 140, and data maintenance module 145 each can include at least one processing unit, server, virtual server, circuit, engine, agent, appliance, or other logic device such as programmable logic arrays configured to communicate with the data structures 150 and 152, and with other computing devices (e.g., the content provider computing device 115, the content publisher computing device 120, or the end user computing device 125) via the network 105.

The data reception module 130, vector generation module 135, distance comparison module 140, and data maintenance module 145 can include or execute at least one computer program or at least one script. In some implementations, the data reception module 130, vector generation module 135, distance comparison module 140, and data maintenance module 145 can be separate components, a single component, or part of the data processing system 110. The data reception module 130, vector generation module 135, distance comparison module 140, and data maintenance module 145 can include combinations of software and hardware, such as one or more processors configured to execute one or more scripts to: (a) receive, retrieve, or otherwise identify one or more domains (or domain names) of a web page; (b) receive, retrieve, or otherwise identify one or more content candidates; (c) maintain, store, or otherwise manage one or more characteristics (e.g., a relevance score) of each of a number of content candidates; (d) generate one or more vectors based on an identified domain; (e) generate one or more vectors based on a selected content candidate; (f) determine a distance over a learned space between two vectors; (g) compare a distance between two vectors with a distance threshold; and (h) associate or disassociate one or more content candidates with a domain.

The data processing system 110 can also include, manage, or interface with one or more content repositories, databases, or data structures, e.g., 150-152. The data structures 150-152 can be local to the data processing system 110. In some implementations, the data structures 150-152 can be remote to the data processing system 110 but can communicate with the data processing system 110 via the network 105. The data structures 150-152 can include web page, content items (e.g., previously created advertisements), primary video content, an advertisement campaign manager, content provider feed, third party content, and annotations, among others, to serve to an end user computing device 125.

The data reception module 130 can receive one or more web resources and corresponding references of one or more web pages provided by a first advertiser through the content provider computing device 115. Examples of the references to the web resources of a web page can include at least one of: a uniform resource locator (URL) of the web page, a link of the web page, and a hyperlink of the web page. The data reception module 130 can receive one or more content candidates provided by a second advertiser through the content provider computing device 115. Each of the content candidates can include a link or a hyperlink. The link, upon being activated (e.g., clicked), can lead to one or more content links. Each content link, upon being activated (e.g., clicked), can lead to one or more landing pages including contents, which the advertiser intended to present. In some implementations, the data reception module 130 can receive any number of content candidates for a web page. In some implementations, the first and second advisers can be identical to or different from each other. For example, the data processing system 110 can associate one or more content candidates, provided by a first advertiser, with a web page, provided by a second, different advertiser.

In response to receiving the web resources (and corresponding references) and content candidates (and corresponding links), the data reception module 130 may store the web resources and corresponding references in the data structure 150, and the content candidates in the data structure 152. The references to the web resources of the web page may be stored or maintained in the data structure 150 as a set of data, an array, a table, among others. Similarly, the links to the content candidates may be stored or maintained in the data structure 152 as a set of data, an array, a table, among others.

In the data structure 152, the data processing system 110, or the data maintenance module 145, can dynamically rank, group, regroup, or otherwise sort the content candidates. In some implementations, the data processing system 110 can rank the content candidates in the data structure 152 based on the respective relevance scores with respect to a domain (or domain name). In some implementations, the system 110 can dynamically update the ranking of the content candidates in the data structure 152 based on the respective updated relevance scores to the domain. In some implementations, the content candidates maintained in the data structure 152 may be a subset of content candidates that the data reception module 130 has received. Such a subset of content candidates may be selected based on the respective click-through-rates satisfying a predetermined rate threshold. For example, upon the data reception module 130 receiving a plurality of content candidates, the data processing system 110 can monitor, for each of the plurality of content candidates, a respective click-through-rate associated with the web page maintained in the data structure 150. The data processing system 110 can select a subset of the plurality of content candidates based on determining that the respective click-through-rate of each of the subset of content candidates satisfies the rate threshold, and store or maintain, in the data structure 152, the subset of content candidates.

The vector generation module 135 can generate a first vector and a second vector based on the sets of data maintained by the data structures 150 and 152, respectively. In some implementations, in response to the data structure 150 storing the reference to the web resources of a web page (e.g., a URL of the web page), the vector generation module 135 can communicate with the data structure 150 to identify, via a natural language processing (NLP) technique or any of various semantic analysis techniques, the reference. Upon identifying the reference, the vector generation module 135 can segment the reference to one or more semantic content candidates. From the one or more semantic content candidates, the vector generation module 135 can select one that represents a domain (or domain name) of the web page. In some implementations, the vector generation module 135 can generate the first vector using the semantic content representing the domain. In some implementations, the vector generation module 135 can generate the first vector based on one or more normalized inputs or features. For example, the vector generation module 135 can check a spelling on the reference, transform each of the characters of the reference to a lower case, and/or split the reference according to one or more word boundaries to generate one or more normalized inputs. Based on each of the one or more normalized inputs, the vector generation module 135 can look up or identify a corresponding vector in a learned space. In response to identifying plural vectors, the vector generation module 135 can generate the first vector by aggregating (e.g., summing, averaging, etc.) the plural vectors.

In some implementations, in response to the data structure 152 storing the links of the number of content candidates, the vector generation module 135 can communicate with the data structure 152 to select one of the content candidates. The vector generation module 135 can identify, via a natural language processing (NLP) technique or any of various semantic analysis techniques, one or more semantic contents of the link of the selected content candidate. Based on the one or more semantic contents of the link, the vector generation module 135 can generate the second vector. In some implementations, the vector generation module 135 can generate the second vector based on one or more normalized inputs or features. For example, the vector generation module 135 can check a spelling on the selected content candidate, transform each of the characters of the selected content candidate to a lower case, and/or split the selected content candidate according to one or more word boundaries to generate one or more normalized inputs. Based on each of the one or more normalized inputs, the vector generation module 135 can look up or identify a corresponding vector in a learned space. In response to identifying plural vectors, the vector generation module 135 can generate the second vector by aggregating (e.g., summing, averaging, etc.) the plural vectors.

The distance comparison module 140 can determine a distance on a learned space between the first vector and the second vector. In some implementations, in response to the vector generation module 135 generating the first and second vectors, the distance comparison module 140 can allocate the first and second vectors on a learned space (e.g., a two-dimensional vector space). The distance comparison module 140 can estimate, calculate, or otherwise determine a distance (e.g., a Hausdorff distance) on the learned space between the first and second vectors. In some implementations, the distance comparison module 140 can monitor, retrieve, or otherwise identify a click-through-rate of the selected content candidate with respect to the web page. Based on the click-through-rate, the distance comparison module 140 can calculate a dot product of the first and second vectors to represent the distance. For example, the distance comparison module 140 can communicate or interface with one of the content provider 115, the content publisher 120, or the end user computing device 125 to identify the click-through-rate of the selected content candidate with respect to the web page. The distance comparison module 140 can calculate the dot product using the identified click-through-rate.

Upon determining the distance between the first and second vectors, the distance comparison module 140 can compare the distance with a predetermined distance threshold and determine whether the distance satisfies the predetermined distance threshold (e.g., less than the distance threshold). In some implementations, if the distance is less than the distance threshold, the distance comparison module 140 can assign the selected content candidate with a relatively high relevance score. On the other hand, if the distance is greater than or equal to the distance threshold, the distance comparison module 140 can assign the selected content candidate with a relatively low relevance score. The relevance score can be used as a measure of how relevant the selected content candidate and the domain are. In some implementations, the vector generation module 135 can periodically select each of the content candidates in the data structure 152 to generate a respective second vector such that the distance comparison module 140 can periodically determine a distance (and a relevance score) between the domain and each of the content candidates. Upon determining the relevance score for each of the content candidates, the distance comparison module 140, or the data maintenance module 145, can store the relevance scores with the respective content candidates in the data structure 152. In some implementations, such a relevance score can be used by the advertiser, for example, to prioritize or deprioritize selecting the corresponding content candidate to be displayed on the web page. In some implementations, the data processing system 110 can use the relevance score to automatically prioritize or deprioritize selecting the corresponding content candidate to be displayed on the web page.

In some implementations, the distance comparison module 140 can generate the distance between the domain and each of the content candidates using a machine learning algorithm or an artificial intelligence algorithm. The distance comparison module 140 can train the machine learning algorithm for generation of the distance (and corresponding relevance score) using one or more previously determined distances.

For example, the distance comparison module 140 can include a neural network or other machine learning algorithm. The distance comparison module 140 can train the neural network using the content candidates that have relatively high relevance scores and/or the content candidates that have relatively low relevance scores. In some implementations, a clustering algorithm can cluster the content candidates based on, for example, the respective relevance scores. Data from the content candidates that have relatively high relevance scores can be parsed into a first set of feature vectors, and data from the content candidates that have relatively low relevance scores can be parsed into a second set of feature vectors. The distance comparison module 140 can train the neural network to generate the weights and biases of the neural network using the first set of feature vectors and/or the second set of feature vectors as training data. Over time (e.g., after a predetermined period or in response to the distance comparison module 140 retrieving updated click-through-rate of the selected content candidate), the selected contentcandidate can then parsed into a feature vector that is input into the trained neural network. The neural network can determine a probability indicating how relevant the selected content candidate and the domain are. Based on the probability, the distance comparison module 140 can generate an updated relevance score for the selected content candidate.

The data maintenance module 145 can associate, responsive to the distance satisfying the distance threshold, the selected content candidate with the domain of the web page. The data maintenance module 145 can disassociate, responsive to the distance not satisfying the distance threshold, the selected content candidate with the domain of the web page. In some implementations, the data maintenance module 145 can communicate with the distance comparison module 140 or the data structure 152 to identify the respective relevance score of each of the content candidates with respect to the domain. The data maintenance module 145 can rank the content candidates in the data structure 152 based on the respective relevance scores. As such, when the advertiser is to select one of the content candidates to be displayed on the web page from the data structure 152, the advertiser can use the ranking of the content candidates to prioritize or deprioritize selecting the content candidate. As described above, the distance comparison module 140 can dynamically (e.g., periodically or responsively) update the relevance scores of the content candidates. The data maintenance module 145 can dynamically update the ranking of the content candidates in accordance with the update on the relevance scores.

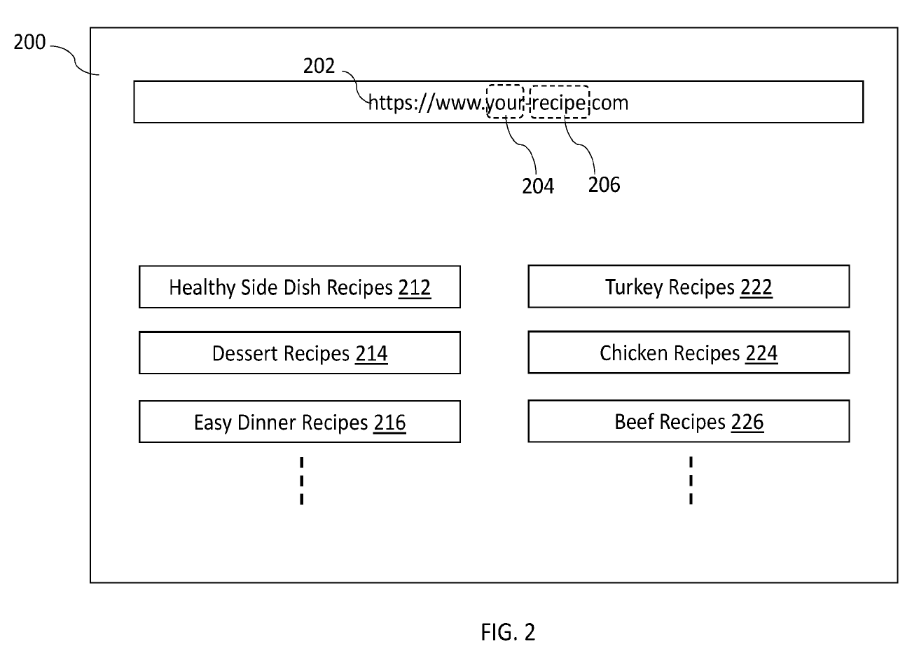

Referring to FIG. 2, an example web page 200 including one or more content candidates that are selected to be displayed is shown. In the context of FIG. 2, the web page includes a reference 202. The reference 202 can include one or more semantic contents candidates, e.g., 204 (“your”) and 206 (“recipe”). Such a reference 202, or semantic contents candidates 204-206, can be maintained in the data structure 150 of the data processing system 110. As discussed above, the data processing system 110 can select one of the candidates as a domain (e.g., 206) of the web page 200. The data processing system 110 can rank a plurality of content candidates maintained in the data stricture 152 of the data processing system 110. As such, one or more of the plurality of content candidates with relatively high relevance scores can be selected in priority, by the advertisers or automatically by the data processing system 110, according to the principle discussed above. As shown, the advertisers or the data processing system 100 can select content candidate 212 (“Healthy Side Dish Recipes”), content candidate 214 (“Dessert Recipes”), content candidate 216 (“Easy Dinner Recipes”), content candidate 222 (“Turkey Recipes”), content candidate 224 (“Chicken Recipes”), and content candidate 226 (“Beef Recipes”) to be displayed on the web page 200, based on a relationship between the semantic content 206 and one or more semantic contents of each of the content candidates 212-226. Each of the content candidates displayed on the web page 200 can include a link that is interactive (e.g., clickable) with an end user.

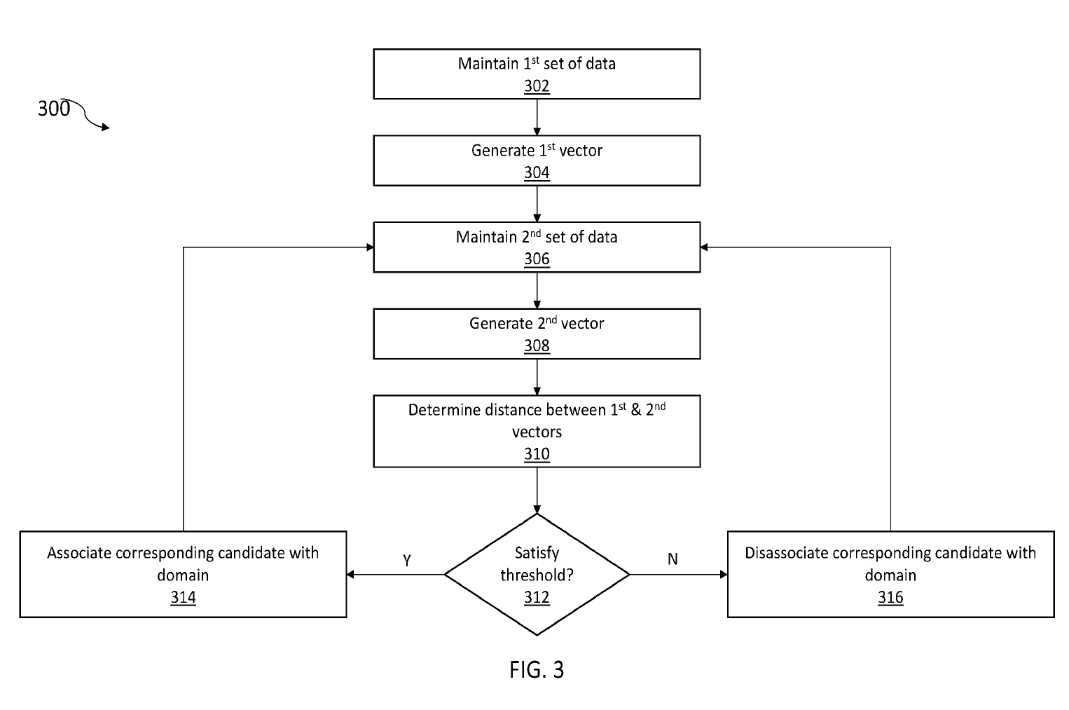

Referring to FIG. 3, depicted is a flow diagram of one implementation of a method 300 for associating content candidates with a web page based on semantic contents of the content candidates. The functionalities of the method 300 can be implemented using, or performed by, the components detailed herein in connection with FIG. 1. The illustrated embodiment of the method 300 is merely an example. Therefore, it should be understood that any of a variety of operations or blocks may be omitted, re-sequenced, and/or added while remaining within the scope of the present disclosure.

In brief overview, the method 300 can include maintaining a first set of data (BLOCK 302). The method 300 can include generating a first vector (BLCOK 304). The method 300 can include maintaining a second set of data (BLOCK 306). The method 300 can include generating a second set of data (BLOCK 308). The method 300 can include determining a distance between the first vector and second vector (BLOCK 310). The method 300 can include a determination of whether the distance satisfies a distance threshold (BLCOK 312). If yes, the method 300 can include associating a corresponding content candidate with a domain (BLOCK 314). If not, the method 300 can include disassociating the corresponding content candidate with the domain (BLOCK 316).

In further detail, the method 300 can include maintaining a first set of data in a first data structure of a system (BLOCK 302). In the context of FIG. 1, the data processing system 100 can receive one or more web resources and corresponding references of one or more web pages through the content provider computing device 115. Examples of the references to the web resources of a web page can include at least one of: a uniform resource locator (URL) of the web page, a link of the web page, and a hyperlink of the web page. In response to receiving the web resources (and corresponding references), the data processing system 110 can store the web resources and corresponding references in the first data structure (e.g., the data structure 150). The references to the web resources of the web page may be stored or maintained in the data structure 150 as a set of data, an array, a table, among others.

The method 300 can include generating a first vector based on a semantic content of the domain of the web page (BLOCK 304). In some implementations, in response to the data structure 150 storing, accepting, or otherwise receiving the reference to the web resources of a web page (e.g., a URL of the web page), the data processing system 110 can communicate with the data structure 150 to identify, via a natural language processing (NLP) technique or any of various semantic analysis techniques, the reference. Upon identifying the reference, the data processing system 110 can segment the reference to one or more semantic content candidates. From the one or more semantic content candidates, the data processing system 110 can select one that represents a domain (or domain name) of the web page. In some implementations, the data processing system 110 can generate the first vector using the semantic content representing the domain. For example, the data structure 150 can store a web page with a reference to the corresponding web resources as https://www.tools.com. The data processing system 110 can determine one of the semantic contents of the reference as such a web page’s domain, for example, “tools.”

The method 300 can include maintaining a second set of data including a subset of content candidates in a second data structure of the system (BLOCK 306). Referring again to FIG. 1, the data processing system 110 can receive one or more content candidates provided through the content provider computing device 115. Each of the content candidates can include a link or a hyperlink. The link, upon being activated (e.g., clicked), can lead to one or more content links. Each content link, upon being activated (e.g., clicked), can lead to one or more landing pages including contents, which the advertiser intended to present. In response to receiving content candidates (and corresponding links), the data processing system 110 may store the content candidates in the second data structure (e.g., the data structure 152). The links to the content candidates may be stored or maintained in the data structure 152 as a set of data, an array, a table, among others.

The method 300 can include generating a second vector based on a semantic content of a selected content candidate (BLOCK 308). In some implementations, in response to the data structure 152 storing, accepting, or otherwise receiving the links of the number of content candidates, the data processing system 110 can communicate with the data structure 152 to select one of the content candidates. The data processing system 110 can identify, via a natural language processing (NLP) technique or any of various semantic analysis techniques, one or more semantic contents of the link of the selected content candidate. Based on the one or more semantic contents of the link, the data processing system 110 can generate the second vector.

The method 300 can include determining a distance on a learned space between the first vector and the second vector (BLOCK 310). In some implementations, in response to the generation of the first and second vectors, the data processing system 110 can allocate the first and second vectors on a learned space (e.g., a two-dimensional vector space). The data processing system 110 can estimate, calculate, or otherwise determine a distance (e.g., a Hausdorff distance) on the learned space between the first and second vectors. In some implementations, the data processing system 110 can monitor, retrieve, or otherwise identify a click-through-rate of the selected content candidate with respect to the web page. Based on the click-through-rate, the data processing system 110 can calculate a dot product of the first and second vectors to represent the distance. For example, the data processing system 110 can communicate or interface with one of the content provider 115, the content publisher 120, or the end user computing device 125 to identify the click-through-rate of the selected content candidate with respect to the web page. The data processing system 110 can calculate the dot product using the identified click-through-rate. For example, the data processing system 110 can use the identified click-through-rate as an input to a predetermined relationship (e.g., a predetermined equation) to determine the distance.

The method 300 can include determining whether the distance satisfies a distance threshold (BLOCK 312). In some implementations, the distance threshold can be predetermined (e.g., a static value), or can be updated (e.g., a dynamic value). The data processing system 110 can dynamically update, adjust, or otherwise create a distance threshold based on various factors. For example, the data processing system 110 can reduce a distance threshold in response to determining a number of the content candidates exceeding a predetermined number. As such, the data processing system 110 can use such a reduced distance threshold as the form of a filter to reduce a total number of the content candidates that the data processing system 110 is to select from.

Referring back to FIG. 3, in response to determining that the distance satisfies (e.g., less than) the distance threshold, the method 300 can include associating the selected content candidate with the domain of the web page (BLOCK 314). Such an association may cause the content candidate to be prioritized to be selected as being displayed on the web page. On the other hand, in response to determining that the distance does not satisfy (e.g., equal to or greater than) the distance threshold, the method 300 can include disassociating the selected content candidate with the domain of the web page (BLOCK 316). Such an disassociation may cause the content candidate to be deprioritized to be selected as being displayed on the web page. Alternatively or additionally, upon being disassociated with a domain, the corresponding content candidate may be removed from the data structure 152. In some implementations, the data processing system 110 can iteratively select each of the content candidates maintained in the data structure 152, generating a respective second vector, and determining a respective distance on the learned space. After comparing the distance between the first and second vectors with the distance threshold (e.g., concurrently with or subsequently to BLOCK 314 or 316), the method 300 can proceed again to BLOCK 306. As such, the data processing system 110 can dynamically update how relevant the content candidates maintained in the data structure 152 and the web page are based on the respective distances (and corresponding relevance scores). For example, the shorter the distance is, the more relevant (the higher the relevance score) the content candidate is. Thus, the content candidate with a higher relevance score may be prioritized to be selected, and the content candidate with a lower relevance score may be deprioritized to be selected. In some implementations, the selected content candidate can be displayed on the web page.

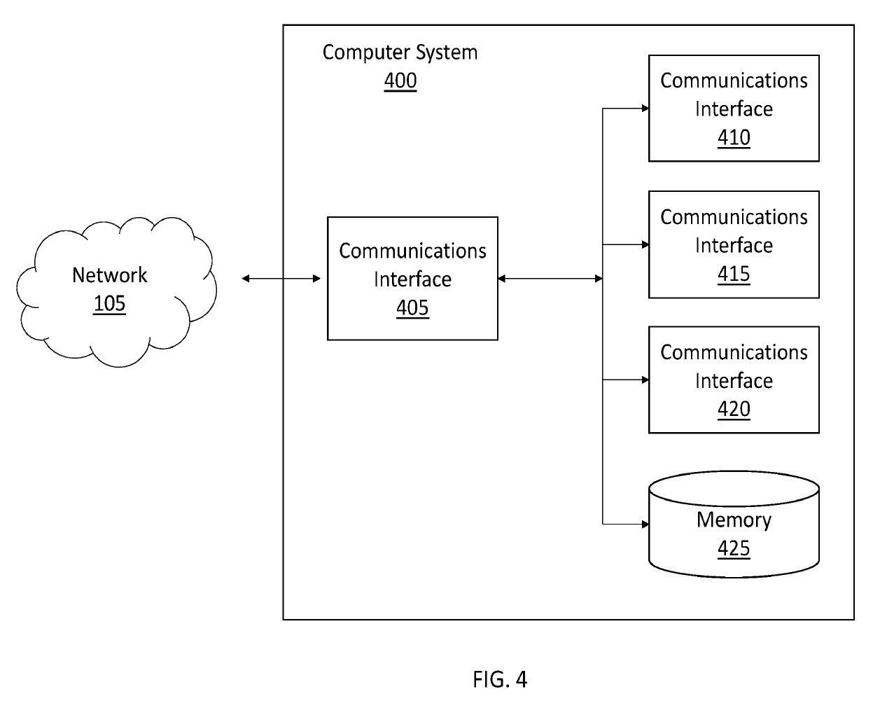

FIG. 4 shows the general architecture of an illustrative computer system 400 that may be employed to implement any of the computer systems discussed herein (including the data processing system 110 and its components such as the various modules 130-145) in accordance with some implementations. The computer system 400 can be used to provide information via the network 105 for display. The computer system 400 of FIG. 3 comprises one or more processors 420 communicatively coupled to memory 325, one or more communications interfaces 405, and one or more output devices 410 (e.g., one or more display units) and one or more input devices 415. The processors 420 can be included in the data processing system 110 or the other components of the system 110 such as the various modules 130-145.

In the computer system 400 of FIG. 4, the memory 425 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 110 of FIG. 1, the data processing system 110 can include the memory 425 to store information related to the availability of inventory of one or more content units, reservations of one or more content units, among others. The memory 425 can include the database 150. The processor(s) 420 shown in FIG. 4 may be used to execute instructions stored in the memory 425 and, in so doing, also may read from or write to the memory various information processed and or generated pursuant to execution of the instructions.

The processor 420 of the computer system 400 shown in FIG. 4 also may be communicatively coupled to or control the communications interface(s) 405 to transmit or receive various information pursuant to execution of instructions. For example, the communications interface(s) 405 may be coupled to a wired or wireless network, bus, or other communication means and may therefore allow the computer system 400 to transmit information to or receive information from other devices (e.g., other computer systems). While not shown explicitly in the system of FIG. 1, one or more communications interfaces facilitate information flow between the components of the system 400. In some implementations, the communications interface(s) may be configured (e.g., via various hardware components or software components) to provide a website as an access portal to at least some aspects of the computer system 400. Examples of communications interfaces 405 include user interfaces (e.g., web pages), through which the user can communicate with the data processing system 400.

The output devices 410 of the computer system 400 shown in FIG. 4 may be provided, for example, to allow various information to be viewed or otherwise perceived in connection with execution of the instructions. The input device(s) 415 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The modules 130-145 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 400 or system 110 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the modules 130-145 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim element.

What is claimed is:

1. A method for providing content candidates, comprising:
maintaining, in a first data structure of a system, a first set of data including a domain of a web page;
maintaining, in a second data structure of the system, a second set of data including a subset of content candidates;
generating, by the system, a first vector based on a semantic content of the domain of the web page;
generating, by the system, a second vector based on a semantic content of a first content candidate selected from the subset of content candidates;
generating, by the system, a third vector based on a semantic content of a second content candidate selected from the subset of content candidates;
determining, by the system, a first distance on a learned space between the first vector and the second vector;
associating, by the system responsive to the first distance satisfying a distance threshold, the first content candidate with the domain of the web page;
determining, by the system, a second distance on the learned space between the first vector and the third vector; and
disassociating, by the system responsive to the second distance not satisfying the distance threshold, the second content candidate with the domain of the web page.

2. The method of claim 1, wherein maintaining a second set of data including a plurality of content candidates further comprises:
receiving, by the system, a plurality of content candidates including the subset of content candidates;
monitoring, by the system for each of the plurality of content candidates, a respective click-through-rate associated with the web page;
selecting, by the system, the subset of content candidates based on determining that the respective click-through-rate of each of the subset of content candidates satisfies a rate threshold; and
storing, in the second data structure, the subset of content candidates.

3. The method of claim 1, wherein generating a first vector based on a semantic content of the domain of the web page further comprises:
identifying, by the system via a natural language processing technique, a reference to web resources corresponding to the web page;
segmenting, by the system, the web address to one or more semantic content candidates; and
selecting, by the system, one of the one or more semantic content candidates as the domain.

4. The method of claim 1, wherein generating a second vector based on a semantic content of a first content candidate selected from the subset of content candidates further comprises:
identifying, by the system via a natural language processing technique, the semantic content of a link of the first content candidate; and
generating, by the system, the second vector based on the semantic content of the link of the first content candidate, and
wherein generating a third vector based on a semantic content of a second content candidate selected from the subset of content candidates further comprises:
identifying, by the system via the natural language processing technique, the semantic content of a link of the second content candidate; and
generating, by the system, the third vector based on the semantic content of the link of the second content candidate.

5. The method of claim 1, wherein determining a first distance on a learned space between the first vector and the second vector further comprises:
identifying, by the system, a click-through-rate of the first content candidate with respect to the web page; and
calculating, by the system, a dot product of the first and second vectors as the first distance based on the click-through-rate of the first content candidate, and
wherein determining a second distance on the learned space between the first vector and the third vector further comprises:
identifying, by the system, a click-through-rate of the second content candidate with respect to the web page; and
calculating, by the system, a dot product of the first and third vectors as the second distance based on the click-through-rate of the third content candidate.

6. The method of claim 1, further comprising:
iteratively determining, by the system, that the first distance is less than the distance threshold;
iteratively assigning, by the system, the first content candidate with a first relevance score to prioritize selecting the first content candidate; and
maintaining, in the second data structure, the first relevance score.

7. The method of claims 1, further comprising:
iteratively determining, by the system, that the second distance is equal to or greater than the distance threshold;
iteratively assigning, by the system, the content candidate with a second relevance score to deprioritize selecting the second content candidate; and
maintaining, in the second data structure, the second relevance score.

8. A system comprising:
one or more hardware processors configured by machine-readable instructions to:
maintain, in a first data structure, a first set of data including a domain of a web page;
maintain, in a second data structure, a second set of data including a subset of content candidates;
generate a first vector based on a semantic content of the domain of the web page;
generate a second vector based on a semantic content of a first content candidate selected from the subset of content candidates;
generating, by the system, a third vector based on a semantic content of a second content candidate selected from the subset of content candidates;
determine a first distance on a learned space between the first vector and the second vector;
associate, responsive to the distance satisfying a distance threshold, the first content candidate with the domain of the web page;
determine, by the system, a second distance on the learned space between the first vector and the third vector; and
disassociate, by the system responsive to the second distance not satisfying the distance threshold, the second content candidate with the domain of the web page.

9. The system of claim 8, wherein the one or more processor are further configured to:
receive a plurality of content candidates including the subset of content candidates;
monitor, for each of the plurality of content candidates, a respective click-through-rate associated with the web page;
select the subset of content candidates based on determining that the respective click-through-rate of each of the subset of content candidates satisfies a rate threshold; and
store, in the second data structure, the subset of content candidates.

10. The system of claim 8, wherein the one or more processor are further configured to:
identify, via a natural language processing technique, a reference to web resources corresponding to the web page;
segment the web address to one or more semantic content candidates; and
select one of the one or more semantic content candidates as the domain.

11. The system of claim 8, wherein the one or more processor are further configured to:
identify, via a natural language processing technique, the semantic content of a link of the first content candidate;
generate the second vector based on the semantic content of the link of the first content candidate;
identify, via the natural language processing technique, the semantic content of a link of the second content candidate; and
generate the third vector based on the semantic content of the link of the second content candidate.

12. The system of claim 8, wherein the one or more processor are further configured to:
identify a click-through-rate of the first content candidate with respect to the web page; and
calculate a dot product of the first and second vectors as the first distance based on the click-through-rate of the first content candidate;
identify a click-through-rate of the second content candidate with respect to the web page; and
calculate a dot product of the first and third vectors as the second distance based on the click-through-rate of the second content candidate.

13. The system of claim 8, wherein the one or more processor are further configured to:
iteratively determine that the first distance is less than the distance threshold;
iteratively assign the first content candidate with a first relevance score to prioritize selecting the first content candidate; and
maintain, in the second data structure, the first relevance score.

14. The system of claim 8, wherein the one or more processor are further configured to:
iteratively determine that the second distance is equal to or greater than the distance threshold;
iteratively assign the second content candidate with a second relevance score to deprioritize selecting the second content candidate; and
maintain, in the second data structure, the second relevance score.

15. A non-transient computer readable medium storing program instructions for causing one or more processors to:
maintain, in a first data structure, a first set of data including a domain of a web page;
maintain, in a second data structure, a second set of data including a subset of content candidates;
generate a first vector based on a semantic content of the domain of the web page;
generate a second vector based on a semantic content of a first content candidate selected from the subset of content candidates;
generate a third vector based on a semantic content of a second content candidate selected from the subset of content candidates;
determine a first distance on a learned space between the first vector and the second vector;
associate, responsive to the first distance satisfying a distance threshold, the first content candidate with the domain of the web page;
determine, by the system, a second distance on the learned space between the first vector and the third vector; and
disassociate, by the system responsive to the second distance not satisfying the distance threshold, the second content candidate with the domain of the web page.

16. The non-transitory computer readable medium of claim 15, wherein the program instructions further causes the one or more processors to:
identify, via a natural language processing technique, a reference to web resources corresponding to the web page;
segment the web address to one or more semantic content candidates; and
select one of the one or more semantic content candidates as the domain.

17. The non-transitory computer readable medium of claim 15, wherein the program instructions further causes the one or more processors to:
identify, via a natural language processing technique, the semantic content of a link of the first content candidate;
generate the second vector based on the semantic content of the link of the first content candidate;
identify, via the natural language processing technique, the semantic content of a link of the second content candidate;
generate the third vector based on the semantic content of the link of the second content candidate.

18. The non-transitory computer readable medium of claim 15, wherein the program instructions further causes the one or more processors to:
identify a click-through-rate of the first content candidate with respect to the web page;
calculate a dot product of the first and second vectors as the first distance based on the click-through-rate of the first content candidate;
identify a click-through-rate of the second content candidate with respect to the web page; and
calculate a dot product of the first and third vectors as the second distance based on the click-through-rate of the second content candidate.

19. The non-transitory computer readable medium of claim 15, wherein the program instructions further causes the one or more processors to:
iteratively determine that the first distance is less than the distance threshold;
iteratively assign the first content candidate with a first relevance score to prioritize selecting the first content candidate; and
maintain, in the second data structure, the first relevance score.

20. The non-transitory computer readable medium of claim 15, wherein the program instructions further causes the one or more processors to:
iteratively determine that the second distance is greater than the distance threshold;
iteratively assign the second content candidate with a second relevance score to deprioritize selecting the second content candidate; and
maintain, in the second data structure, the second relevance score.
